(19) United States
(12) Patent Application Publication
(10) Pub. No.: US 2008/0283235 A1
(43) Pub. Date: Nov. 20, 2008

(54) Apparatus and a method for cooling a condenser of an air conditioner

(76) Inventor: Dave Verenkoff, Henderson, NV (US)

Correspondence Address: REED SMITH LLP, Suite 1400, 3110 Fairview Park Drive, Falls Church, VA, 22042, US

(21) Appl. No.: 11/798,450

(22) Filed: May 14, 2007

(51) Int. Cl. G05D 23/19

(52) U.S. Cl. 165/281

(57) ABSTRACT

An apparatus for cooling a condenser of an air conditioner comprises a support member, a tube arranged around a condenser of an air conditioner, a spray comprising an inlet coupled with the tube and an outlet arranged so as to spray water onto the condenser, an air deflector being arranged adjacent the condenser, a sun shade being coupled with the support member and arranged above the condenser; and a sail switch comprising a sail disposed in the air deflector so as to detect an air flow exhausted from the condenser, a switch lever coupled with the switch and extending into the air deflector and a switch placed adjacent the air deflector. The tube is coupled with a water supply. The switch controls water supplied to the tube from the water supply according to an orientation of the sail. The apparatus further comprises a screen or drape around the condenser.

### FIELD OF INVENTION

The invention relates to an apparatus and a method for cooling a condenser of an air conditioner installed outdoor, particularly Carnot cycle based air conditioners installed outdoor.

### BACKGROUND OF THE INVENTION

Refrigerated air conditioning is generally based on Carnot cycle of heat rejection and absorption associated with the compression and the expansion of a refrigerant. In the cycle course, a refrigerant is compressed by a pump at a condenser placed outdoor; the refrigerant heats up as the refrigerant liquefies; the heat is removed from the liquidated refrigerant as the liquidated refrigerant passes through coils and is cooled down by forcing air around the coils to flow through the coils; and the heat is discharged into the atmosphere, which acts as an infinite heat sink. The cooled liquid refrigerant, which is still under high pressure by compression, is routed to a second heat exchange unit placed in a building. In the second heat exchange unit, the cooled liquid refrigerant is allowed to expand and evaporate through an expansion valve. Because a liquid absorbs heat energy where the liquid changes its state to a gaseous state, the refrigerant absorbs heat from the air in the building by circulating the air around the coils in the second heat exchange unit in the building with a blower fan while the refrigerant evaporates and travels through coils in the second heat exchange unit in the building. The refrigerant which absorbed heat in the building returns to the condenser placed outdoor to undergo the above-explained compression stage, and then, the next cycle starts.

A condenser of an air conditioner for a residential house or a commercial building is generally installed outdoor. Exposure of the condenser to sun light causes the temperature of the coils in the condenser to increase. Because the temperature of the surroundings of the coils in the condenser increases, the refrigerant has to absorb additional heat caused by sun light in addition to the heat of the room air to be cooled down. As a result, the efficiency of the air conditioner to cool down the air in the building decreases.

To improve the efficiency of an air conditioner, a condenser placed outdoor need to be cooled down. One way to solve this problem is to arrange a sun shade above or around a condenser. However, because the sun shade prevents hot air exhausted from the condenser during operation from being released away from the atmosphere around the condenser, the exhausted hot air stays around the condenser, and causes the temperature of the coils in the condenser to increase.

Another way to solve this problem is to cool down the coils in the condenser by spraying or misting water onto the condenser by measuring a temperature of the atmosphere around the condenser. However, the condenser stops its operation while the temperature of a room to be cooled down by the air conditioner is cooled down to a predetermined room temperature. If an outdoor temperature is higher than a predetermined outdoor temperature even though the condenser is not in operation, a sensor detects such a high temperature, and water is unnecessarily sprayed or misted onto the condenser.

### SUMMARY OF THE INVENTION

The objective of the present invention is to provide an apparatus and a method for cooling a condenser placed outdoor to save electrical energy consumed by the air conditioner by preventing unnecessary heat-up of the coils in the condenser and cooling down the coils in the condenser while the condenser is in operation.

Another objective of the present invention is to provide a package-type apparatus for cooling a condenser placed outdoor and make it easy to install the apparatus onto a condenser that has been already placed outdoor.

### BRIEF DESCRIPTION OF THE DRAWINGS

FIG. 1 is a perspective view of one embodiment of an apparatus for cooling a condenser of an air conditioner of the present invention.

FIG. 2 is a perspective view illustrating placement of a tube and sprays on the condenser.

FIG. 3 is a perspective view of another embodiment of the present invention in which an inline filter is installed between a tube and a water valve.

FIG. 4 is a perspective view of another embodiment of an apparatus for cooling a condenser of an air conditioner of the present invention.

FIG. 5 is a perspective view of another embodiment of an apparatus for cooling a condenser of an air conditioner of the present invention.

### DETAILED DESCRIPTION

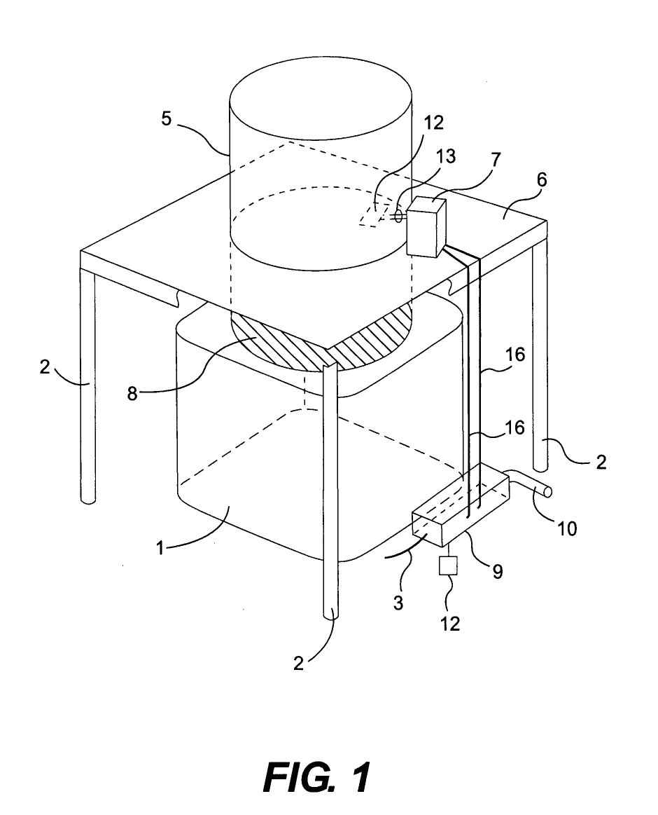

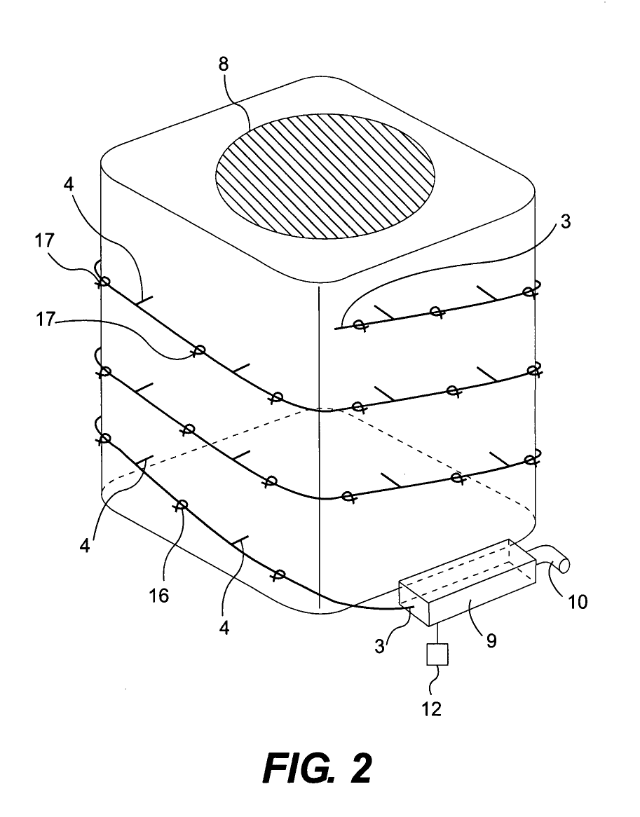

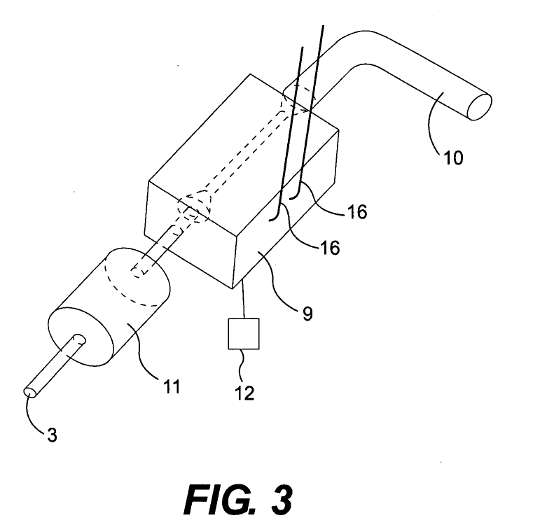

FIG. 1 shows a perspective view of one embodiment of an apparatus for cooling a condenser 1 of an air conditioner. The apparatus comprises a support member 2, a tube 3, one or more sprays 4, an air deflector 5, a sun shade 6, and a sail switch 7. The tube 2 and one or more sprays 4 is omitted in FIG. 1. An exemplary placement of the tube 2 and one or more sprays 4 is shown in FIG. 2. However, the placement of the tube 2 and one or more sprays 4 is not limited to the one shown in FIG. 2. The support member 2 comprises four legs. The top of each leg is connected with the sun shade 6. The bottom of the four legs may be adapted to be anchored to the ground. The sun shade 6 may be circular, square, or rectangular. The area which the sun shade 6 covers is larger than the area of an exhaust grid 8 of the condenser 1. Alternatively, heat insulation is installed on a side of the sun shade 6 facing to the condenser 1. The heat insulation absorbs the sun light, and therefore, prevents heat transfer to the condenser 1, particularly a cool air intake of the condenser 1. The air deflector 5 is mounted around the condenser grid 8, which is an outlet to exhaust hot air. The horizontal cross-section of the air deflector 5 is circular, square or rectangular. Alternatively, the horizontal cross-section of the air deflector 5 is of substantially the same size and the same shape as those of the exhaust grid 8. The sun shade 6 has a hole to insert the air deflector 5. The air deflector 5 prevents hot air exhausted from the exhaust grid 8 from flowing back into the cool air intake of the condenser 1 while the condenser 1 is in operation. Alternatively, all of the air deflector 5, the sun shade 6, and the support member 4 are configured in a single package so that it is easily install on the condenser which has been already placed outdoor. The tube 3 is arranged around the condenser 1. Alternatively, the tube 3 wraps the area of the cool air intake of the condenser 1. Alternatively, the tube wraps the condenser helically, as shown in FIG. 2. The tube 3 may be secured to a plurality of points on the condenser 1. Alternatively, the tube 3 is secured to the support member 2. Alternatively, as shown in FIG. 2, the tube 3 is tied with UV resistant nylon strings 16 at a plurality of points on the condenser 1. Alternatively, the tube 3 is tied with UV resistant nylon strings 16 at a plurality of points on the support members 2. The tube 3 may be made of any material including a plastic, nylon, metal, fiber grass and so on. The tube 3 is coupled with a water valve 9 which is coupled with a water source 10 such as the public water supply, a water reservoir, and a water tank. As shown in FIG. 3, an inline filter 11 may be installed between the water valve 9 and the water source 10. The water valve 9 is electrically operable and coupled with the sail switch 7 and a power supply 12. The tube 3 is coupled with one or more sprays 4. An outlet of the spray 6 is arranged so as to spray water onto the condenser. The sail switch 7 is placed near the air deflector 5. The sail switch 7 comprises a sail 12, a switch lever 13 and a switch 14. One end of the switch lever 13 is coupled with the sail 12 and the other end is coupled with the switch 14. The sail 12 is disposed in the air deflector 5. A switch lever 13 extends into the air deflector 5 through an opening on the side of the air deflector 5. The switch 14 is disposed outside the air deflector and coupled with the water valve 9 via leads 16. The sail detects an air flow from the condenser according to the orientation of the sail. The switch 14 is turned on in response to the orientation of the sail being substantially vertical by air flow from the condenser 1. The switch 14 is turned off in response to the orientation of the sail being substantially horizontal. The power supply 12 is turned on so as to open the water valve in response to the switch 14 being turned on. The power supply 12 is turned off so as to close the water valve in response to the switch 14 being off. Alternatively, a power control switch coupled with the switch 14 is coupled between the power supply 12 and the water valve 9. While the power supply 12 is on, the water valve 9 is opened by turning on the power control switch in response to the switch 14 being turned on, and the water valve 9 is closed by turning off the power control switch in response to the switch 14 being turned off.

Hot air is exhausted from the condenser only while it is in operation. Therefore, in this apparatus, the water is sprayed or misted onto the condenser while the condenser is in operation. The water is not sprayed or misted onto the condenser while the condenser 11 is not in operation, because the sail switch 7 does not detect air flow from the condenser since hot air is not exhausted from the condenser while it is not in operation.

Alternatively, a sensor for detecting air flow is placed on a route of air flow from the condenser grid 8. The sensor may be placed in the air deflector or near the outlet of the air deflector 2. An output of the sensor indicates whether the condenser 11 is in operation by detecting the air flow from the condenser grid 8. The sensor is coupled with the controller and an output of the sensor is transmitted to the controller. The controller controls the water valve 10, which is electrically operable, to open or close according to the output of the sensor. The water valve 10 is coupled with a power source and the controller controls the water valve 10 by controlling turn-on/off of the power source.

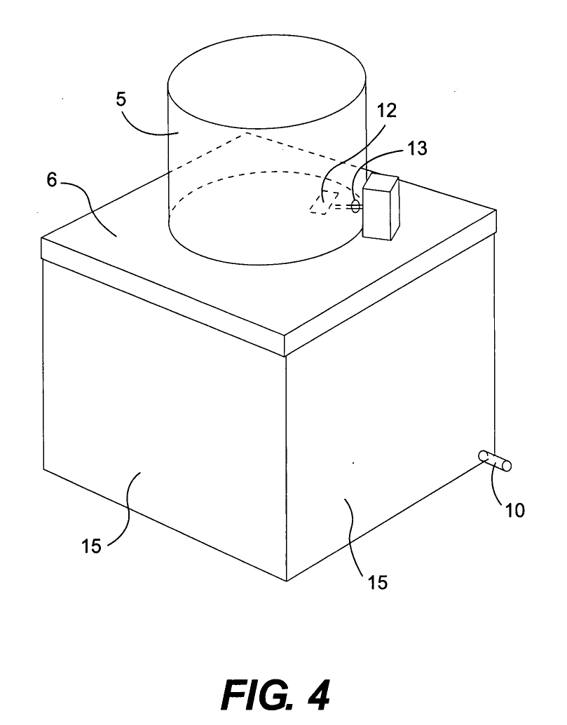

FIG. 4 shows a perspective view of another embodiment of an apparatus for cooling a condenser 1 of an air conditioner. The apparatus comprises a support member 2, a tube 3, one or more sprays 4, an air deflector 5, a sun shade 6, a sail switch 7, and a screen 15. The screen 15 is arranged around the condenser 1. Alternatively, the screen 5 covers an entire side of the condenser 1. The screen 15 is coupled with the support member 2. Alternatively, the screen 15 is replaced with at least one drape. Alternatively, the material of the screen or drape 15 is sun and/or heat resistant. Alternatively, all of the air deflector 5, the sun shade 6, the support member 4, and the screen 15 are configured in a single package so that it is easily install on the condenser which has been already placed outdoor. The structures, the functions and the arrangement of the support member 2, the tube 3, the one or more sprays 4, the air deflector 5, the sun shade 6, the sail switch 7 and the water valve 9 are the same as those in the embodiments as described above.

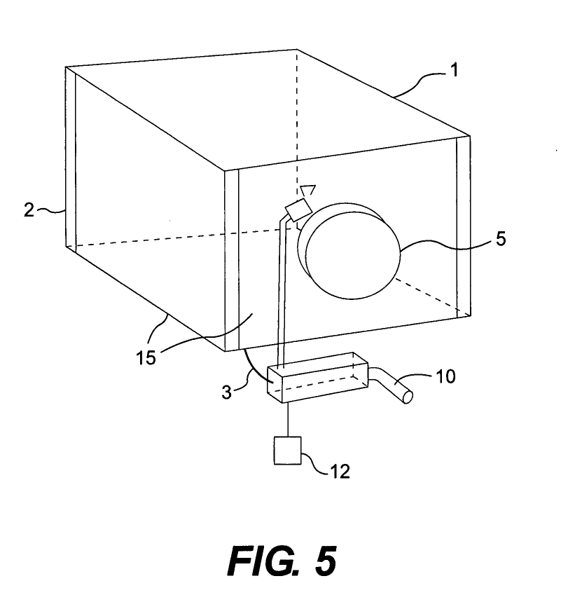

FIG. 5 shows a perspective view of another embodiment of an apparatus for cooling a condenser 1 of an air conditioner. The apparatus comprises a support member 2, a tube 3, one or more sprays 4, an air deflector 5, a sun shade 6, a sail switch 7 or sensor to detect an air flow, and a screen 15. The screen 15 is arranged around the condenser 1. Alternatively, the screen 5 covers an entire side of the condenser 11. The air deflector 5 is arranged at one side of the condenser 1. A part of the screen 15 comprises a hole into which the air deflector 5 is to be inserted. Alternatively, the screen 15 is coupled with the support member 2. Alternatively, all of the air deflector 5, the sun shade 6, the support member 4, and the screen 15 are configured in a single package so that it is easily install on the condenser which has been already placed outdoor. In FIG. 5, the tube 3 and sprays 4 are omitted, however, the structures, the functions and the arrangement of the one or more sprays 4, the sail switch or the sensor to detect an air flow, and the water valve 9 are the same as those in the embodiments described above.

What is claimed is:

1. An apparatus for cooling a condenser of an air conditioner, comprising:
a support member;
a tube arranged around a condenser of an air conditioner, the tube being coupled with a water supply;
a spray comprising an inlet and an outlet, the inlet being coupled with the tube, the outlet being arranged so as to spray water onto the condenser;
an air deflector being arranged adjacent the condenser;
a sun shade being coupled with the support member and arranged above the condenser; and
a sail switch comprising a sail, a switch lever and a switch, the sail disposing in the air deflector so as to detect an air flow exhausted from the condenser, the switch lever coupled with the switch and extending into the air deflector, the switch being placed adjacent the air deflector, wherein the switch controls water supplied to the tube from the water supply according to an orientation of the sail.

2. The apparatus according to claim 1, further comprising a water valve coupled with the switch and the water supply.

3. The apparatus according to claim 2, wherein the water valve is electrically operable and coupled with a power supply.

4. The apparatus according to claim 1, wherein the switch is turned on in response to a plane of the sail being substantially vertical, and the switch is turned off in response to the plane of the sail being substantially horizontal.

5. The apparatus according to claim 4, wherein the power supply supplies power to the water valve so as to open the water valve when the switch is on and the power supply supplies no power to the water valve so as to close the water valve when to the switch is off.

6. The apparatus according to claim 4, further comprising a power control switch coupled with the switch and the power supply,
wherein the power control switch is turned on so as to supply power to the water valve from the power supply so as to open the water valve in response to the switch being turned on and the power control switch is off so as to supply no power to the water valve from the power supply so as to close the water valve in response to the switch being turned off.

7. The apparatus according to claim 1, wherein the sun shade comprises a hole adapted for inserting the air deflector, wherein at least an outlet of the air deflector is arranged above the sun shade.

8. The apparatus according to claim 1, further comprising a heat insulation disposed on a side of the sun shade, the side facing to the condenser.

9. The apparatus according to claim 1, wherein the tube is secured to a plurality of the points on the condenser.

10. The apparatus according to claim 1, wherein the tube is secured to the support member.

11. The apparatus according to claim 1, further comprising at least one screen, the at least one screen being arranged near the condenser.

12. The apparatus according to claim 1, further comprising a screen covering an entire side of the condenser.

13. The apparatus according to claim 11, wherein a material of the at least one screen is sun and/or heat resistant.

14. The apparatus according to claim 12, wherein a material of the screen is sun and/or heat resistant.

15. The apparatus according to claim 11, wherein the at least one screen is coupled with the support member.

16. The apparatus according to claim 12, wherein the screen is coupled with the support member.

17. The apparatus according to claim 1, further comprising a drape, the drape being arranged to cover the condenser.

18. The apparatus according to claim 17, wherein a material of the drape is sun and/or heat resistant.

19. The apparatus according to claim 17, wherein the drape is coupled with the support member.

20. An apparatus for cooling a condenser of an air conditioner, comprising:
a support member;
a tube arranged around a condenser of an air conditioner, the tube coupled with a water supply;
a spray comprising an inlet and an outlet, the inlet being coupled with the tube, the outlet being arranged so as to spray water onto the condenser;
an air deflector being arranged adjacent the condenser;
a sun shade being coupled with the support member and arranged above the condenser; and
a sensor adapted to defect an air flow, the sensor being placed adjacent the air deflector so as to detect an air flow exhausted from the condenser; and
a switch coupled with the sensor and the water supply, wherein the switch controls water supplied to the tube from the water supply.

21. The apparatus according to claim 20, further comprising a water valve coupled with the switch and the water supply, the water valve being electrically operable and coupled with a power supply.

22. The apparatus according to claim 21, wherein the switch is turned on in response to the switch detecting an air flow from the condenser, and the switch is turned off in response to the switch detecting substantially no air flow from the condenser.

23. The apparatus according to claim 22, wherein the power supply supplies power to the water valve so as to open the water valve when the switch is on and the power supply supplies no power to the water valve so as to close the water valve when the switch is off.

24. The apparatus according to claim 21, further comprising a control switch coupled with the switch and the power supply,
wherein the control switch is on so as to supply power to the water valve from the power supply so as to open the water valve in response to the switch being turned on and the control switch is off so as to supply no power to the water valve from the power supply so as to close the water valve in response to the switch being turned off.

25. The apparatus according to claim 20, wherein the sun shade comprises a hole adapted for inserting the air deflector, wherein at least an outlet of the air deflector is arranged above the sun shade.

26. The apparatus according to claim 20, further comprising a heat insulation disposed on a side of the sun shade, the side facing to the condenser.

27. The apparatus according to claim 20, wherein the tube is secured to a plurality of the points on the condenser.

28. The apparatus according to claim 20, wherein the tube is secured to the support member.

29. The apparatus according to claim 20, further comprising at least one screen, the at least one screen being arranged near the condenser.

30. The apparatus according to claim 20, further comprising a screen covering an entire side of the condenser.

31. The apparatus according to claim 29, wherein a material of the at least one screen is sun and/or heat resistant.

32. The apparatus according to claim 30, wherein a material of the screen is sun and/or heat resistant.

33. The apparatus according to claim 29, wherein the at least one screen is coupled with the support member.

34. The apparatus according to claim 30, wherein the screen is coupled with the support member.

35. The apparatus according to claim 20, further comprising a drape, the drape being arranged to cover the condenser.

36. The apparatus according to claim 35, wherein a material of the drape is sun and/or heat resistant.

37. The apparatus according to claim 36, wherein the drape is coupled with the support member.

38. A method for cooling a condenser of an air conditioner, comprising the steps of:
placing a condenser cooling package comprising
a support member;
a tube arranged around a condenser of an air conditioner, the tube being coupled with a water supply;
a spray comprising an inlet and an outlet, the inlet being coupled with the tube, the outlet being arranged so as to spray water onto the condenser;
an air deflector being arranged near the condenser;
a sun shade being coupled with the support member and arranged above the condenser;
a sail switch comprising a sail, a switch lever and a switch, the sail disposing in the air deflector so as to detect an air flow exhausted from the condenser, the switch lever coupled with the switch and extending into the air deflector, the switch being placed adjacent the air deflector, wherein the switch controls water supplied to the tube from the water supply; and
a screen being arranged around the condenser;
detecting an air flow exhausted from the condenser by the sail;
turning on and off the switch according to an orientation of the sail;
controlling the water valve according to a status of the switch; and
spraying water onto the condenser.

39. The method according to claim 38, wherein the switch is turned on in response to a plane of the sail being substantially vertical, and the switch is turned off in response to the plane of the sail being substantially horizontal.
